(19) United States
(12) Patent Application Publication
(10) Pub. No.: US 2015/0202800 A1
(43) Pub. Date: Jul. 23, 2015

(54) METHOD FOR MANUFACTURING A MOLDING TOOL INTENDED FOR MOLDING A PART MADE OF COMPOSITE MATERIAL

(71) Applicant: TECHNI-MODUL ENGINEERING, Coudes (FR)

(72) Inventor: Serge Luquain, Saint Germain Lembron (FR)

(21) Appl. No.: 14/418,315

(22) PCT Filed: Aug. 5, 2013
(86) PCT No.: PCT/FR2013/051879

§ 371 Date: Jan. 29, 2015

(30) Foreign Application Priority Data
Aug. 3, 2012 (FR) 12/57593

(51) Int. Cl. B29C 33/38; B29C 33/04; B29C 70/44; B29C 70/34; B29C 70/86

(52) U.S. Cl. CPC B29C 33/3842; B29C 70/34; B29C 70/865; B29C 70/443; B29C 33/3828; B29C 33/04; B29C 2033/385; B29C 2033/042; B29K 2995/0012; B29K 2705/08

(57) ABSTRACT

The present invention concerns a method for producing a mould intended for moulding a composite part, in particular intended for the wind power, nautical or aeronautical technical fields. The mould is made from a composite material. Moreover, the heat transfer fluid circuit (2) that said mould comprises is made during the mould production process. The circuit (2) comprises at least one tube made from a material with a low thermal expansion coefficient, advantageously close to that of the composite material.

### TECHNICAL FIELD

The invention relates to the field of molding tool, and more particularly to molding parts made of composite material with large dimensions, used in particular in the fields of aeronautics, boating and wind energy.

### BACKGROUND

In certain sectors of activity, such as that of aeronautics, boating or wind energy, numerous parts, often with large dimensions, are made of composite materials. The optimization and parameterization of the shape of these parts have been the subject of highly advanced studies. This is why, during the production in series of these parts, and more particularly during their molding, it is essential to have a molding tool of high quality and high precision allowing to obtain a molded part, the shape of which perfectly complies with the parameters determined during its devising and which has no defect.

We mean by composite material, within the context of the present invention, a material constituted of:
a frame (or in other words a reinforcement) made from fibers, which ensures the mechanical strength of the composite material

and
a matrix, in this particular case a thermosetting or a thermoplastic resin, which ensures the cohesion of the composite material.

When the resin is a thermosetting resin, the molding tool must be subjected to a thermal cycle perfectly established depending on the selected molding method and on the nature of the resin, in such a manner as to obtain the adequate hardening of the resin, due to its polymerization, within the network of fibers. The thermal cycle generally comprises the following steps:

1) a 1^{st} rise in temperature from room temperature to a temperature of a 1^{st} holding stage (at around 100° C.);

2) the holding of the temperature at this 1^{st} temperature stage during a determined period;

3) a 2^{nd} rise in temperature from the temperature of the 1^{st} holding stage to a temperature of a 2^{nd} holding stage (at around 180° C.);

4) the holding of the temperature at this 2^{nd} temperature stage during a determined period. During this step, the hardening of the thermosetting resin (or in other words its polymerization or its cross-linking) is carried out;

5) a drop in temperature from the temperature of the 2^{nd} holding stage to the stripping temperature (of around 60° C.).

Depending on the selected molding method, the number of temperature holding stages may vary from 1 to 10.

When the resin is a thermoplastic resin, the molding tool must also be subjected to a perfectly established thermal cycle depending on the selected molding method and on the nature of the resin, in such a manner as to obtain the adequate hardening of the resin within the network of fibers. In this case, the thermal cycle may comprise one single temperature rise step and one single cooling step. There is no need for holding the temperature such as described above in the case of a thermosetting resin.

During the cooling phase of the thermal cycle, if the molding tool is made of steel or aluminum, it exerts mechanical stresses on the part made of composite material which has just been molded. Indeed, the thermal expansion coefficient of a composite material is generally of the order of 2.5 10⁻⁶ K⁻¹ or lower than that of steel (12.10⁻⁶ K¹) or aluminum (24.10⁻⁶ K⁻¹) of which the molding tool is usually constituted. This is why, during cooling, the molded part made of composite material is “caught in a vice” by the molding tool, due to the retraction of the molding tool which is more important than that of the molded part made of composite material. That can considerably damage the molded part by causing the appearance of cracks, or even break it, and thus particularly if the latter is with large dimensions. For example, on a steel molding tool of a length of 4 m, a retraction of the order of 7 mm may occur.

In order to be rid of this issue caused by the retraction difference between the molding tool and the molded part during cooling, it is possible to consider hot stripping the part which has just been molded, namely generally at a temperature of the order of 180° C. However, this solution has safety issues.

It is also possible to use a molding tool in steel commercialized under brand name INVAR®. Indeed, the INVAR® is a steel with a thermal expansion coefficient of 1.2 10⁻⁶ K⁻¹ which, as a result, does not induce mechanical stresses in the part made of composite material during the cooling step. However, this alloy is very expensive, and of the order of ten times the cost of a steel of which is usually constituted a molding tool.

It has also been considered to have a molding tool also made of composite material. In this manner, the molding tool and the molded part being constituted of a same material, the issue caused by the retraction difference between the molding tool and the molded part during the cooling no longer arises.

Furthermore, the management of the steps of the thermal cycle described above is achieved thanks to a heat carrying fluid circulating inside the molding tool.

It is essential that the circulation of the heat carrying fluid is designed and dimensioned in such a manner as to respect the temperature rise and drop rates, as well as the thermal homogeneities of the temperature holding stages.

For this:
the surface of exchange between the heat carrying fluid and the molding tool should be sufficient for providing the power necessary for respecting the temperature rise and drop rates of the thermal cycle.
the positioning of the heat carrying fluid circuit within the molding tool should be defined accurately, in order to respect the thermal homogeneities at the temperature holding stages. Advantageously, the distance between the heat carrying fluid circuit and the molding surface of the molding tool must be constant.

In order to allow producing a heat carrying fluid circuit inside the molding tool compliant with the aforementioned requirements, several solutions, such as drilling, the integration of tubes or even the grooving have been implemented during the manufacturing of a molding tool.

However, these different solutions exhibit drawbacks.

The drilling solution which consists in drilling cylindrical passages in the molding tool is not suitable for complex shell shapes of which can be constituted the molding tool. Indeed, the drillings being straight, it is difficult to produce a passage at a constant distance from the molding surface of the molding tool in all points. In addition, this technique is dimensionally limited. The maximum straight length which may be produced by drilling is of the order of 12 meters.

The solution of grooving and assembling consists in producing grooves in the molding tool in order to create the passage of the heat carrying fluid. A plate is then added and screwed in order to close the heat carrying fluid circuit. An O-ring is implanted outside this grooving between the shell of the molding tool and the plate in such a manner as to ensure sealing of the heat carrying fluid circuit. This technique is also limited to molding tools with noncomplex shape. In addition, it is produced by machining and remains expensive. Finally, depending on the duration of service life of the molding tool, this solution may require maintenance (for example replacing the O-ring).

Finally, the solution of the integration of tubes consists in integrating tubes at the step of producing the metal base by casting or welding. It is limited to molding tools produced in foundry or to molding tools of noncomplex shape (integration by welding). Furthermore, this technique generates an additional thermal interface (tube) between the heat carrying fluid and the molding surface of the molding tool. This results in the damaging of the thermal performances (rate and homogeneity) of the molding tool.

Furthermore, during molding a part made of composite material, the molding tool may be subjected to high temperatures of the order of 180° C. However, when the tool is subjected to such temperatures, the molding tool, as well as the tubes which are made of different materials will tend to expand differently, due to their different thermal expansion coefficients. This expansion difference may have the following consequences:
In some cases, the tubes expand, this induces deformations of the molding tool which may lead to cracks, or even a bursting of the molding tool. The higher the temperature at which the molding tool is subjected, the more these defects increase.
The tubes slide inside the molding tool. The quality of the surface of exchange between the heat carrying fluid and the molding tool is thus no longer guaranteed. Due to the displacement of the heat carrying fluid circuit, the thermal homogeneities at the temperature holding stages are no longer respected.

One solution to this issue of thermal expansion difference may consist in stiffening the molding tool, for example by increasing its thickness. This would indeed allow decreasing the deformation induced by the thermal expansion of the tubes. However, the drawback of this solution is that it increases the weight of the molding tool, as well as the costs of the materials to manufacture it. In other words, this solution is not fully satisfactory.

This is why, when it is opted for the producing of the heat carrying fluid circuit formed from tubes, it is essential to choose in an appropriate manner the material of which are constituted the tubes, in order to prevent damage which may be fatal for the molding tool during the usage thereof at high temperatures of the order of 180° C.

Moreover, the composite material, particularly when it mainly consists of carbon fibers and epoxide resin, is a material which is difficult to machine. It requires the use of specific and expensive cutting tools. Furthermore, the dust generated during the machining of such a composite material is hazardous for the operator and requires taking restrictive measures.

It is easily understood from this description of the related art in terms of molding tool that the design and the devising of a molding tool intended for molding a part made of composite material proves to be particularly complex. Particularly, the known methods of manufacturing molding tool are not well adapted for producing a heat carrying fluid circuit which may cross, in an optimal manner for the thermal exchanges, the entire molding surface of the molding tool.

### BRIEF SUMMARY

The present invention remedies to all these drawbacks by proposing a method for manufacturing a molding tool which is perfectly appropriate for molding any part made of composite material.

The method for manufacturing a molding tool intended for molding a part made of composite material according to the invention is characterized in that it comprises the following steps:

a) A support is provided.

b) On the support is disposed a first stacking of reinforcing fibers which are possibly impregnated with a thermosetting or a thermoplastic resin.

c) On the first stacking of reinforcing fibers is disposed a circuit comprising at least one tube made of a material of low thermal expansion coefficient, said circuit having the shape of a heat carrying fluid circuit adapted to the molding tool.

d) On the circuit is disposed a second stacking of reinforcing fibers which are possibly impregnated with a thermosetting or a thermoplastic resin.

e) The set constituted by the first stacking of reinforcing fibers, the circuit, the second stacking of reinforcing fibers, is compressed, and where appropriate when the reinforcing fibers are not impregnated with a thermoplastic or a thermosetting resin, a thermoplastic or a thermosetting resin is infused.

f) A thermal cycle is carried out, said thermal cycle being designed in such a manner as to harden the thermosetting or the thermoplastic resin in order to obtain a molded shape.

g) The molded shape obtained from step f) is stripped.

We mean by heat carrying fluid circuit adapted to the molding tool, within the context of the present invention, that the heat carrying fluid circuit is adapted to:
the geometric shape of the molding tool;
the thermal regulation of the molding tool.

in step e) of the manufacturing method according to the invention, where appropriate when the reinforcing fibers are not impregnated with a thermoplastic or a thermosetting resin, a thermoplastic or a thermosetting resin is infused in such a manner as to impregnate said reinforcing fibers with resin.

In addition, the molding tool obtained according to the manufacturing method of the invention has the following advantages:
The sealing of the heat carrying fluid circuit may be verified prior to its setting up on the first stacking of reinforcing fibers. Thus, this prevents the risk of obstructing the heat carrying fluid circuit by a resin which would make the molding tool unusable.
During the molding operations with the molding tool obtained according to the manufacturing method of the invention, the heat carrying fluid circuit may be subjected to a high pressure of the order of 30 bars, without risk of delaminating the composite material of which the molding tool is constituted.
The surface of the heat carrying fluid circuit being smooth, the head loss is hardly high, because the passage of the heat carrying fluid is facilitated.

Furthermore, the manufacturing method according to the invention has the advantage of not requiring a step of machining the composite material of which it is constituted. However, it is known that the machining of material constituted of carbon fibers and epoxide resin is difficult and requires the use of specific and expensive cutting tools. The manufacturing method is free of all these machining issues.

The reinforcing fibers are advantageously selected from the group consisting of the carbon fibers, glass fibers, aramide fibers, metal fibers (for example made of aluminum), vegetable fibers such as wood fibers and cotton fibers, ceramic fibers, taken alone or in combination of the latter.

The thermosetting resin may be selected from the group consisting of the unsaturated polyester resins, epoxide resins, vinylester resins, phenolic resins, polyimide resins, polystyryl-pyridrine resins.

The thermoplastic resin may be selected from the group consisting of the polyether ether ketones, polyamids, polyetherimides, polyethylenes, polystyrenes, polypropenes.

The material with a low thermal expansion coefficient of the tube is advantageously selected from the materials of which the thermal expansion coefficient is lower than 25.10⁻⁶ K⁻¹, preferably comprised between 1.10⁻⁶ K⁻¹ and 3.5 10⁻⁶K⁻¹, even more preferably comprised between 1.5 10⁻⁶ K⁻¹ and 3.5 10⁻⁶ K⁻¹.

In a preferred manner, the material with a low thermal expansion coefficient of the tube is selected from the group consisting of steel, stainless steel, copper, carbon, metal alloys, titanium, ceramics and composite materials.

Preferably, it consists of steel, and even more preferably of the INVAR®.

The material of the tube is selected in an appropriate manner so that its thermal expansion coefficient is close to that of the composite material (namely a mixture of reinforcing fibers and resin) comprised in the molding tool obtained from the manufacturing method according to the invention.

To this end, in practice, the thermal expansion coefficient of the composite material (namely this mixture of reinforcing fibers and resin) comprised in the molding tool may be evaluated throughout tests prior to the implementation of the manufacturing method according to the invention. This will allow choosing the material of the tube of which the thermal expansion coefficient is the closest to that of the thus evaluated composite material, and hence the most appropriate for manufacturing the molding tool according to the invention.

We mean by close thermal expansion coefficients that the difference between these coefficients, expressed in absolute value, is advantageously lower than 10, preferably lower than 3.

In this manner, when the molding tool will be subjected to polymerization cycles at high temperatures during the molding of a part, the molding tool and the tubes forming the heat carrying fluid circuit will expand without an important expansion difference occurring between the materials which constitute them and which may be the cause of the slipping of the tubes, or even the cracks and the bursting of the molding tool.

In addition, the molding tool obtained according to the manufacturing method will not pose an issue caused by the retraction difference between the molding tool, the circuit composed of a tube made of a material of low thermal expansion coefficient and the molded part made of composite material during cooling, since the materials used have approximately the same thermal expansion.

Finally, the fact that the material of the tube is selected in an adequate manner so that there be no thermal expansion difference issue between the tube and the composite material comprised in the molding tool, the method according to the invention also has the advantage of not requiring to manufacture a stiff molding tool, for example of important thickness. In an advantageous embodiment of the invention, this material further has an elongation with break higher than 5%. Accordingly, the material has a sufficient elongation to allow the bending of the tubes and thus produce a reliable heat carrying fluid circuit.

In an advantageous embodiment of the invention, the circuit comprises a unique tube made of a steel with a low thermal expansion coefficient, for example INVAR®.

The shaping of the circuit is produced by any method within the range of the skilled person, such as bending, welding, folding, sticking and brazing. A large-dimensioned complex shape of the heat carrying fluid circuit is technically easy to obtain with the manufacturing method according to the invention. Indeed, the heat carrying fluid circuit may be in the form of a tube which is disposed with precision on the first stacking of reinforcing fibers so that it perfectly ensures its function of heat transfer in a homogenous manner throughout the entire molding tool.

The method for manufacturing a molding tool according to the invention thus proposes a producing of the heat carrying fluid circuit within the molding tool not requiring complex technical means, nor hazardous from a safety standpoint.

The part molded by means of the molding tool obtained according to the manufacturing method such as described above is molded in entirely suitable molding conditions, since the molding tool is crossed in an optimal manner by the heat carrying fluid circuit, and thus all the portions of the part made of composite material have benefited from the same thermal exchanges.

According to an embodiment of the invention, in step b) is disposed a stacking of reinforcing fibers which have been impregnated with a thermoplastic or a thermosetting resin, the set constituted by the reinforcing fibers and the resin being in the form of a composite fabric.

According to this embodiment of the invention, step b) is carried out by successively repeating the following operations until obtaining a first stacking of reinforcing fibers of a determined thickness:

i. a plurality of composite fabrics (for example 2 to 3) are disposed over each other in such a manner as to form a stacking of composite fabrics;

ii. the stacking of composite fabrics is compressed by establishing vacuum, and thus for example by covering them with a perforated film, a draining fabric and a vacuum bag;

iii. optionally, the stacking of composite fabrics is subjected to an appropriate thermal cycle for hardening the resin of which are impregnated the reinforcing fibers of the composite fabrics.

Thus, after step ii), where appropriate after step iii), on the thus obtained stacking of composite fabrics may be disposed several composite fabrics in order to carry out once again steps i) to ii), where appropriate steps i) to iii).

It is worth noting that with this embodiment of the invention, it is considered not to carry out step iii), or not to systematically carry out this step iii) of hardening the resin, but to successively repeat only steps i) and ii).

In other words, in a certain alternative of this embodiment of the invention, the resin present in all of the stackings of composite fabrics may not have been hardened after step b), if only steps i) and ii) were successively repeated.

According to an embodiment of the invention, in step d) is disposed a second stacking of reinforcing fibers which were impregnated with a thermoplastic or a thermosetting resin (in other words, a stacking of composite fabrics is disposed).

According to this embodiment of step d), the following operations are successively repeated until obtaining a second stacking of reinforcing fibers of a determined thickness:

i. a plurality of composite fabrics (for example 2 to 3) are disposed on each other in such a manner as to form a stacking of composite fabrics;

ii. the stacking of composite fabrics are compressed by establishing vacuum, and thus for example by covering them with a perforated film, a draining fabric and a vacuum bag;

iii. optionally, the stacking of composite fabrics is subjected to an appropriate thermal cycle for hardening the resin of which are impregnated the reinforcing fibers of the composite fabrics,

and the repetition of said operations i) to ii) is finished, where appropriate i) to iii) by a step i).

Thus after step ii), where appropriate, step iii), on the thus obtained stacking of composite fabrics can be disposed a plurality of composite fabrics for carrying out again steps i) to ii), where appropriate steps i) to iii).

It is worth noting that when in step ii) the stacking of composite fabrics is compressed, the set constituted by the first stacking of reinforcing fibers, the heat carrying fluid circuit and the stacking of composite fabrics constituting the second stacking of reinforcing fibers is compressed.

In other words, when steps i) and ii), where appropriate steps i) to iii), are repeated several times, step d) is finished by a step i) during which composite fabrics are disposed on the previous stacking of composite fabrics. The following step is step e) of the method according to the invention, during which the set constituted by the first stacking of reinforcing fibers, the circuit and the second stacking of reinforcing fibers is compressed.

According to another embodiment of the invention, step b) is carried out in the following manner:

i. reinforcing fibers are disposed on the support;

ii. the reinforcing fibers are compressed by establishing vacuum, and this for example by covering them with a tear fabric, a draining fabric and a vacuum bag.

iii. Thermosetting or thermoplastic resin is infused in such a manner as to impregnate the reinforcing fibers with resin.

Then according to this embodiment of the invention, step e) may be carried out in the following manner:
the set constituted by the first stacking of reinforcing fibers, the circuit and the second stacking of reinforcing fibers is compressed by establishing vacuum, and this for example by covering the second stacking of reinforcing fibers with a tear fabric, a draining fabric and a vacuum bag;
a thermoplastic or a thermosetting resin is infused in such a manner as to impregnate the reinforcing fibers with resin

Within the context of the present invention, we mean by “establishing vacuum” that a depression of the order of 1 bar is created. In order to reinforce the compression force, this compacting step may be carried out in an autoclave.

According to a preferred embodiment of the invention, the molding face of the molding tool is constituted by the face which was in contact with the support up to step g) of stripping. In this embodiment, during the design of the support the retraction difference between the support and the molding tool must have been taken into consideration during the cooling in order to mold a molding surface of the molding tool in the shape required for the molding of a part made of composite material. This embodiment is preferred as it does not require any machining of the molding surface of the molding tool.

According to another embodiment, the molding face of the molding tool is constituted by the face opposite to that which was in contact with the support up to step g) of stripping. In this embodiment, it is hence necessary to carry out finishing in such a manner as to obtain the required molding surface for the molding of a part made of composite material. According to this embodiment of the invention, the method for manufacturing a molding tool hence comprises an additional step of machining the molding surface of the molding tool.

According to an embodiment of the invention, in step d), on the circuit is disposed a second stacking of reinforcing fibers in such a manner that after the manufacturing method according to the invention, the height of the second stacking of reinforcing fibers is substantially equal to or higher than the outer diameter of the tube of the heat carrying fluid circuit. The adjusting of the quantity of reinforcing fibers to be disposed is perfectly accessible to the person, for example by means of experimental tests.

According to another embodiment of the invention, on the circuit is disposed a second stacking of reinforcing fibers in such a manner that after the manufacturing method according to the invention, the height of the second stacking of reinforcing fibers is lower than the outer diameter of the tube of the heat carrying fluid circuit. In this embodiment of the invention, the face opposite to that which was in contact with the support up to step g) of stripping thus has a warped appearance. This face cannot constitute a molding surface of the molding tool.

This embodiment of the invention has the advantage with respect to the preceding one to be less expensive. Indeed, savings of materials (reinforcing fibers and resin) are made in step d) where less reinforcing fibers are disposed on the heat carrying fluid circuit.

Furthermore, experimentations have shown that the deviation between the maximum temperature and the minimum temperature (AT) of the molding surface was substantially the same, of the order of 3° C., during a thermal cycle of a method for molding a part made of composite material, and this whatever the thickness of the second stacking of reinforcing fibers impregnated with resin. In other words, this last embodiment described is advantageous regarding the cost of the materials but also, it is as efficient as to the homogeneities in temperature of the molding surface as the embodiment in which the height of the second stacking of reinforcing fibers is substantially higher than or equal to the outer diameter of the tube of the heat carrying fluid circuit.

The invention also relates to a molding tool intended for molding a part made of composite material likely to be obtained according to the method for manufacturing a molding tool such as described above.

In a preferred manner, the part made of composite material is a part intended for the technical field of aeronautics, boating and wind energy.

The manufacturing method according to the invention thus reconciles an easy technical implementation with reduced costs, while steering clear of safety issues.

### BRIEF DESCRIPTION OF THE DRAWINGS

The invention will be better understood by means of the detailed description which is exposed below with reference to the accompanying drawing representing, by way of non limiting example, an embodiment of the different elements constituting the molding tool.

FIG. 1 is an exploded perspective view of the different elements constituting the molding tool and the heat carrying fluid circuit.

FIG. 2 is a front view of the heat carrying fluid circuit.

FIG. 3 is a perspective view of the different elements constituting the molding tool and the heat carrying fluid circuit.

FIG. 4 is a sectional view of the different elements constituting the molding tool and the heat carrying fluid circuit according to line IV-IV of FIG.

### DETAILED DESCRIPTON

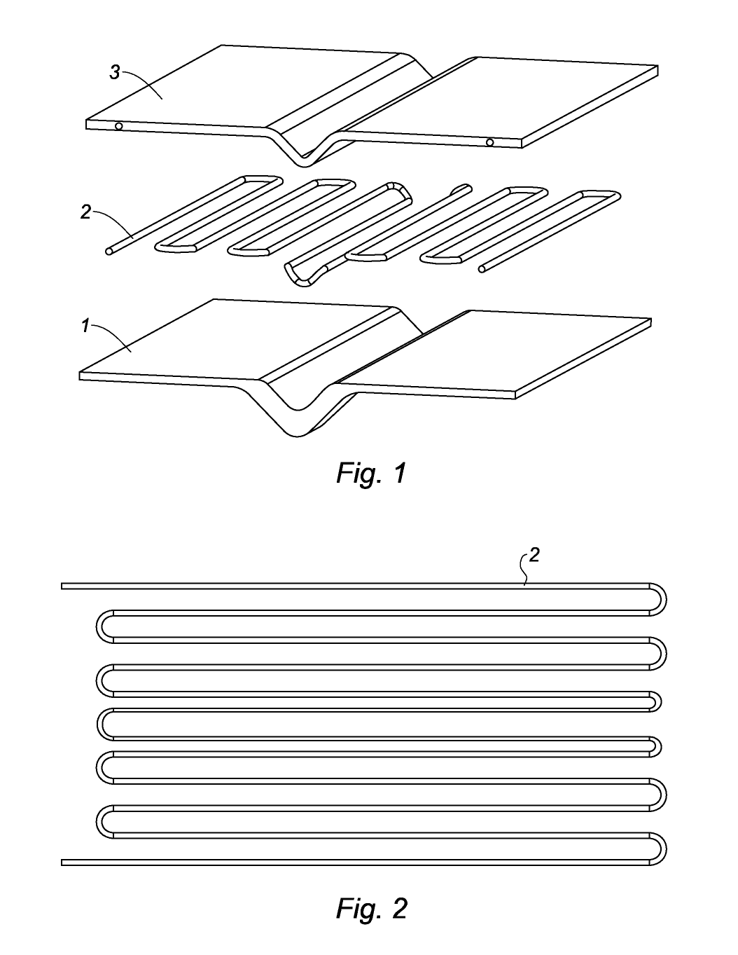

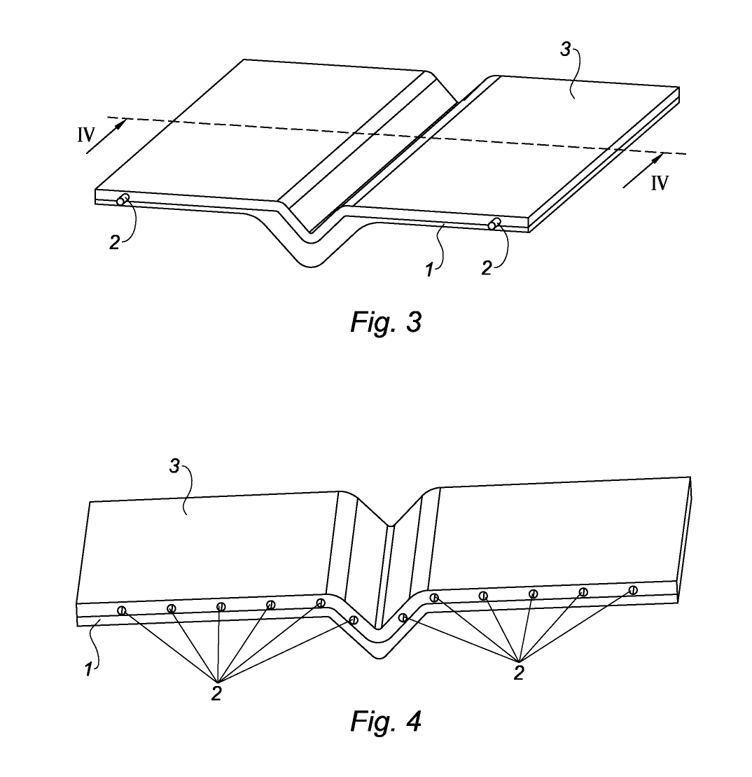

On FIG. 1 are represented:
a first stacking 1 of reinforcing fibers impregnated with resin;
a second stacking 3 of reinforcing fibers impregnated with resin;
a heat carrying fluid circuit 2

The reinforcing fibers are carbon fibers impregnated with an epoxide resin. The volumetric ratio of the carbon fibers is comprised between 55 and 60% with respect to the volume of the mixture constituted of carbon fibers and epoxide resin. The first stacking 1 of reinforcing fibers impregnated with resin and the second stacking 3 of reinforcing fibers impregnated with resin have a curved shape according to the desired curvature of the molding surface of the molding tool.

The circuit 2 comes in the form of a tube. The material constituting the circuit 2 is INVAR®. The circuit 2 has been obtained by welding the tubes in INVAR® by the welding method TIG (Tungsten Inert Gas). The length of the circuit 2 is around 1 m.

During step f) of the method for manufacturing the molding tool, the epoxide resin present in the first stacking 1 and the second stacking 3 of reinforcing fibers becomes dispersed in all these stackings 1, 3 of reinforcing fibers and hardens.

Thus, a molding tool made of composite material of carbon fibers and epoxide resin is obtained which includes a circuit 2 intended for the transport of a heat carrying fluid.

A first molding tool obtained according to the manufacturing method according to the invention has been described above. It consisted of a molding tool made of a composite material (mixture of carbon fibers and epoxide resin) comprising a heat carrying fluid circuit constituted of INVAR®.

The thermal expansion coefficient of the INVAR® is of 1.2 10⁻⁶ K⁻¹ and that of the composite material constituted of the mixture of carbon fibers and epoxide resin such as detailed above is of 2.10⁻⁶ K⁻¹. Thus, these two thermal expansion coefficient values are close to one another.

Moreover, a second molding tool has been produced. This second molding tool was distinguished from the first molding tool only in that the material of the tube forming the heat carrying fluid circuit was in copper. Copper has a thermal expansion coefficient of 17.10⁻⁶ K⁻¹. Thus, for this second molding tool, the thermal expansion coefficient of the material of the tube was very different from the thermal expansion coefficient of the composite material comprised in this second molding tool.

The first and second molding tools have been subjected to the following conditions:
water circulation in the heat carrying fluid circuit at a maximum temperature of 160° C.;
apparatus for heating the molding tool at a power of 12 kW. The maximum heating rate was around 10° C./min.

After 4 to 5 minutes of heating, for the second molding tool, cracks have been noted at the angles of the heat carrying fluid circuit, as well as a slipping of this circuit in the rectilinear parts thereof. These noted cracks and slipping originate from the expansion of the copper of the heat carrying fluid circuit.

During the rise in temperature of the second molding tool, the copper tube expanded much more than the rest of the second molding tool constituted of a mixture of carbon fibers and epoxide resin.

The first molding tool remained intact, without any crack and no slipping of the circuit has been noted.

Thus, this example proves that the material of which is constituted the tube of the heat carrying fluid circuit should be chosen scrupulously depending on the composite material comprised in the molding tool (namely a mixture of reinforcing fibers and resin) so that the molding tool can be subjected to the usual temperatures of polymerization cycle which are generally of the order of 180° C., and this without undergoing any damage (deformations, cracks, or even bursting).

Regarding the composite material constituted of a mixture of carbon fibers and epoxide resin such as detailed above, unlike INVAR®, copper has proved not to be a satisfactory material for the tube of the heat carrying fluid circuit which is used in the context of the producing method according to the invention.

The material of the tube is chosen in an appropriate manner so that its thermal expansion coefficient is close to that of the composite material (namely a mixture of reinforcing fibers and a resin) comprised in the molding tool.

1. A method for manufacturing a molding tool intended for molding a part made of composite material, comprising:
a) providing a support is provided;
b) disposing on the support a first stacking of reinforcing fibers which are possibly impregnated with a thermosetting or a thermoplastic resin;
c) disposing on the first stacking of reinforcing fibers a circuit comprising at least one tube made of a material of low thermal expansion coefficient, said circuit having the shape of a heat carrying fluid circuit adapted to the molding tool;
d) disposing on the circuit a second stacking of reinforcing fibers which are possibly impregnated with a thermosetting or a thermoplastic resin;
e) compressing the set constituted by the first stacking of reinforcing fibers, the circuit, the second stacking of reinforcing fibers and where appropriate when the reinforcing fibers are not impregnated with a thermoplastic or a thermosetting resin, a thermoplastic or a thermosetting resin is infused;
f) carrying out a thermal cycle being designed in such a manner as to harden the thermosetting or the thermoplastic resin in order to obtain a molded shape; and
g) stripping the molded shape obtained from step f).

2. The method for manufacturing a molding tool according to claim 1, wherein the material with a low thermal expansion coefficient is selected from the materials of which the thermal expansion coefficient is lower than 25.10⁻⁶ K⁻¹.

3. The method for manufacturing a molding tool according to claim 2, wherein the material with a low thermal expansion coefficient is selected from the group consisting of steel, stainless steel, copper, carbon, metal alloys, titanium, ceramics and composite materials.

4. The method for manufacturing a molding tool according to claim 1, wherein the material with a low thermal expansion coefficient is INVAR®.

5. The method for manufacturing a molding tool according to claim 1, wherein step b), the reinforcing fibers have been impregnated with a thermoplastic or a thermosetting resin, the set constituted by the reinforcing fibers and the resin being in the form of a composite fabric and in that step b) is carried out by successively repeating the following operations until obtaining a first stacking of reinforcing fibers of a determined thickness:
i. a plurality of composite fabrics are disposed on each other in such a manner as to form a stacking of composite fabrics;
ii. the stacking of composite fabrics is compressed by establishing vacuum;
iii. optionally, the stacking of composite fabrics is subjected to an appropriate thermal cycle for hardening the resin of which are impregnated the reinforcing fibers of the composite fabrics.

6. The method for manufacturing a molding tool according to claim 1, wherein step d), the reinforcing fibers were impregnated with a thermoplastic or a thermosetting resin, the set constituted by the reinforcing fibers and the resin being in the form of a composite fabric and in that step d) is carried out by successively repeating the following operations until obtaining a second stacking of reinforcing fibers of a determined thickness:
i. a plurality of composite fabrics are disposed on each other in such a manner as to form a stacking of composite fabrics;
ii. the stacking of composite fabrics is compressed by establishing vacuum;
iii. optionally, the stacking of composite fabrics is subjected to an appropriate thermal cycle for hardening the resin of which are impregnated the reinforcing fibers of the composite fabrics,
and the repetition of said operations i) to ii) is finished, where appropriate i) to iii), by a step i).

7. The method for manufacturing a molding tool according to claim 1, wherein step b) is carried out in the following manner:
Reinforcing fibers are disposed on the support;
The reinforcing fibers are compressed by establishing vacuum;
Thermosetting or thermoplastic resin is infused in such a manner as to impregnate the reinforcing fibers with resin.

8. The method for manufacturing a molding tool according to claim 7, wherein step e) is carried out in the following manner:
the set constituted by the first stacking of reinforcing fibers, the circuit and the second stacking of reinforcing fibers is compressed by establishing vacuum;
a thermoplastic or a thermosetting resin is infused in such a manner as to impregnate the reinforcing fibers with resin.
